(19) United States
(12) Patent Application Publication
(10) Pub. No.: US 2026/0097478 A1
(43) Pub. Date: Apr. 9, 2026

(54) DRIVING TOOL

(71) Applicant: Illinois Tool Works Inc., Glenview, IL (US)

(72) Inventors: Kévin BOUBEKEUR, Bourg-Les-Valences (FR); Olivier BAUDRAND, Beaumont-lès-Valence (FR)

(21) Appl. No.: 19/352,642

(22) Filed: Oct. 8, 2025

(30) Foreign Application Priority Data
Oct. 9, 2024 (FR) 2410922

(51) Int. Cl. B25C 1/06; B25C 1/18

(52) U.S. Cl. CPC B25C 1/06; B25C 1/18

(57) ABSTRACT

A driving tool comprising an energy storage device holder with an open-ended receptacle for holding an energy storage device. The holder also comprises a connector at a closed end of the receptacle for connecting to the energy storage device and a gripper for engaging at least part of a lateral side of the energy storage device when it is connected to the connector. The gripper can be moved from a retracted position to a deployed position to engage the energy storage device.

### PRIORITY CLAIM

This patent application claims priority to and the benefit of French Patent Application No. 2410922, filed Oct. 9, 2024, the entire contents of which is incorporated herein by reference.

### TECHNICAL FIELD

The present disclosure generally relates to driving tools, in particular a holder for an energy storage device, such as a battery or fuel cartridge for driving tools.

### BACKGROUND

Energy storage device holders for driving tools typically comprise a connector, an electrical or fluid connection, and a contact or outlet for the energy storage device. The connector usually comprises a mechanical connection that is sufficient to secure the energy storage device.

### SUMMARY

The present disclosure aims to provide a holder for an energy storage device that holds it more effectively inside the device. The present disclosure also aims to provide a holder that enables more efficient temperature control of the energy storage device.

The present disclosure relates to a holder for an energy storage device for a driving tool, the holder comprising a receptacle and at least one gripper for engaging the energy storage device.

The inventors observed that the recoil caused by firing the driving tool can exert pressure on the connector and can even dislodge the energy storage device in certain circumstances. The presence of at least one gripper that engages with the energy storage device can mitigate this problem.

The presence of at least one gripper that engages with the energy storage device enables thermal contact between the two, which can be used to control the temperature of the energy storage device. For example, it can be useful to cool the batteries if the driving tool is used frequently.

Similarly, when fuel is extracted from a fuel cartridge in use, part of the remaining fuel vaporizes, which reduces the temperature of the fuel in the fuel cartridge. One of the consequences of the reduced temperature in the cartridge is an ensuing drop in the pressure of the cartridge and of the fuel it contains.

The inventors found that this reduced pressure can affect the injection system and, in extreme cases, cause the tool to fail, if the combustion-powered tool is used continuously for long periods.

The present disclosure therefore enables a more efficient heat transfer between a temperature control mechanism and the energy storage device.

The energy storage device can comprise a battery. The driving tool can comprise an electric or electromagnetic driving mechanism.

Alternatively, the energy storage device can comprise a fuel cartridge. The driving tool can comprise a combustion-powered tool, which can have a combustion chamber.

The receptacle can have an open end, for example to hold the energy storage device. The holder can comprise a connector. The connector can be at one end of the receptacle, which can be closed, for example to connect to the energy storage device or a connector on the energy storage device. The connector on the energy storage device can comprise a battery contact for making an electrical connection or a fuel cartridge outlet for making a fluid connection.

The gripper can be for engaging at least part of a lateral side or of a side wall of the energy storage device, for example when it is connected to the connector. The gripper can be moved from a retracted position to a deployed position to engage the energy storage device.

An energy storage device holder for a driving tool, the holder comprising an open-ended receptacle for holding an energy storage device, a connector at a closed end of the receptacle for connecting with the energy storage device, and at least one gripper for engaging at least part of a lateral side of the energy storage device when connected to the connector, in which the gripper can be moved from a retracted position to a deployed position to engage the energy storage device.

The lateral side of the energy storage device can comprise a side wall. The gripper can be for engaging at least part of a side wall of the energy storage device, for example when it is connected to the connector.

The gripper can be actuated or actionable from its retracted position to its deployed position by a force, which can be applied to push the energy storage device into the holder and/or to connect it to the connector, for example connecting the connector on the energy storage device.

More specifically, the gripper can be actuated from its retracted position to its deployed position by a force applied to push the energy storage device into the holder and/or to connect it to the connector.

The gripper can comprise a stop. The stop can be configured to be engaged by the energy storage device, for example when it is inserted into the holder.

More specifically, the gripper can comprise a stop configured to engage the energy storage device when it is inserted into the holder.

The gripper can be connected, for example moveably, to the holder by at least one swivel link. The gripper can be movably connected to the holder by at least one, for example two, swivel link(s) so that a force applied to push the gripper toward the closed end of the receptacle causes it to move to the inside of the receptacle, from its retracted position to its deployed position. The force applied to push the gripper toward the closed end of the receptacle can correspond to the force applied to push the energy storage device into the holder and/or to connect it to the connector.

More specifically, the gripper can be movably connected to the holder by at least one swivel link so that the force applied to push the energy storage device into the holder causes the gripper to move to the inside of the receptacle, from its retracted position to its deployed position.

The swivel link(s) can comprise or provide a mechanism with four bars. The or each swivel link can be connected, for example pivotally, to the receptacle, for example to a wall of the receptacle, at one of its ends and/or to the gripper or to the elongate member at its other end.

The gripper can comprise an elongate member. The elongate member can comprise an engagement surface. The engagement surface can be configured to engage with the energy storage device, for example on its lateral side or its side wall and/or over most or all of its length.

More specifically, the gripper can comprise an elongate member with an engagement surface for engaging on the lateral side of the energy storage device over most or all of its length.

The surface can be curved and/or concave, for example at least partially cylindrical.

More specifically, the engagement surface can be at least partially cylindrical.

The gripper can comprise a resilient member. The resilient member can form the engagement surface, for example in such a way as to ensure contact over at least part, for example substantially all, of the engagement surface.

More specifically, the gripper can comprise a resilient member that forms the engagement surface so as to ensure contact over substantially all of the engagement surface.

The resilient member can comprise a foam material.

The gripper or resilient member can comprise a metal part, such as a metal foil. The metal part can be on the foam material. The metal part can form the engagement surface.

In some cases, the foam can be thermally conductive. The foam can comprise a thermally conductive or heat-conducting foam. The foam can comprise thermally conductive particles, such as metal particles. The foam material can also comprise a non-metallic, thermally conductive material. The foam can comprise a thermally conductive silicone sponge.

The gripper or stop can comprise a flange. The flange can comprise a stop surface. The stop surface can be substantially perpendicular to the engagement surface. The stop surface can be configured to be engaged by the energy storage device when it is inserted into the energy storage device, for example when it is inserted into the holder.

More specifically, the stop can comprise a flange with a stop surface substantially perpendicular to the engagement surface, which is configured to be engaged by the energy storage device when it is inserted into the holder.

The stop or the stop surface can be configured to be engaged by a shoulder on the energy storage device, for example, that surrounds the connector on the energy storage device.

The gripper can be biased toward its retracted position.

The gripper can be biased by a spring.

More specifically, the gripper can be biased toward its retracted position by a spring.

The spring can be a tension spring or an elastic band. The spring can connect the gripper, for example the elongate member on the gripper, to a bracket located at or near the open end of the receptacle. The advantage is that regardless of the position of the driving tool, the gripper is always in the retracted position when the energy storage device is not in the tool.

The holder can comprise a stop, which can be adjacent to the swivel connection between the or each swivel link and the receptacle. The stop or stops can be used to limit the movement of the swivel link or of the gripper, for example in the deployed position. The stop(s) can be used to limit the movement of the swivel link or of the gripper, which would otherwise cause the gripper to retract away from the energy storage device.

The at least one gripper can be part of a pair of grippers, which can engage on different or opposite sides, for example opposite lateral sides, of the energy storage device. The pair of grippers can produce a clamping effect.

Each gripper can comprise one or more of the features described above.

The present disclosure also relates to a driving tool. The driving tool can comprise an energy storage device holder, for example as described above.

The present disclosure also relates to a driving tool comprising an energy storage device holder as described above.

The driving tool can comprise a temperature control device. The temperature control device can be connected, for example operationally, to the gripper. The temperature control device can be configured to heat and/or cool the energy storage device.

More specifically, the driving tool can comprise a temperature control device operationally connected to the gripper and configured to heat or cool the energy storage device held in the receptacle.

The temperature control device can be operationally connected to the metal part of the gripper.

The driving tool can comprise an energy storage device. The energy storage device can comprise a battery or a fuel cartridge.. The connector on the energy storage device can comprise a battery contact, for example, to make an electrical connection. The connector on the energy storage device can comprise an outlet from the fuel cartridge, for example, to make a fluid connection.

The driving tool can comprise an electric or electromagnetic driving mechanism, for example when the energy storage device comprises a battery.

Alternatively, the driving tool can comprise a combustion-powered tool, for example when the energy storage device comprises a fuel cartridge. The driving tool can comprise a combustion chamber, which can be fluidly connected to the connector on the holder.

More specifically, the driving tool can comprise a combustion chamber fluidly connected to the connector on the holder and a fuel cartridge with a side wall and an outlet fluidly connected to the connector on the receptacle, in which the gripper is in a deployed position to engage the fuel cartridge.

The driving tool can comprise a nailer or a stapler.

The present disclosure also relates to a combustion-powered tool comprising a fuel cartridge holder as described above and a combustion chamber fluidly connected to the connector on the holder.

The combustion-powered tool can comprise a fuel cartridge. The fuel cartridge can comprise a side wall and/or an outlet. The outlet can be fluidly connected to the connector on the receptacle. The gripper can be in the deployed position, for example to engage in the fuel cartridge.

The combustion-powered tool can comprise a nailer or a stapler.

In order to avoid any doubt, all the features described herein also apply to any aspect of the present disclosure.

In order to avoid any ambiguity, the terms “can,” “and/or” “for example,” and any other similar term used in the present document are to be interpreted as not limiting, such that any feature thus described is not necessarily required to be present.

### BRIEF DESCRIPTION OF THE SEVERAL VIEW OF THE FIGURES

Other features and advantages of the present disclosure will become apparent from the following detailed description, which will be understood in reference to the appended drawings.

FIG. 1 illustrates a diagram of a driving tool comprising an energy storage device holder according to one example embodiment of the present disclosure.

FIG. 2 illustrates a cross-sectional view of the holder in FIG. 1 before an energy storage device is inserted therein.

FIG. 3 illustrates a view similar to the one in FIG. 2 while the energy storage device is being inserted.

FIG. 4 illustrates a view similar to that in FIGS. 2 and 3 when the energy storage device is fully inserted.

### DETAILED DESCRIPTION

While the systems, devices, and methods described herein may be embodied in various forms, the drawings show, and the specification describes certain exemplary and non-limiting embodiments. Not all of the components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

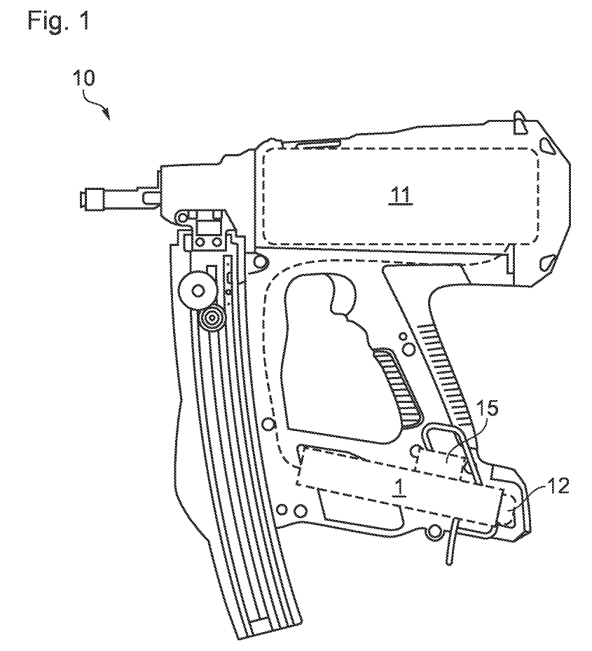

Referring now to FIG. 1, a driving tool 10 can be seen, which is a combustion-powered tool in this example. The combustion-powered tool 10 comprises a combustion chamber 11 and an energy storage device holder 1 inside which an energy storage device 12, in this example a fuel cartridge, is held. In this example, the combustion-powered tool 10 is a nailer.

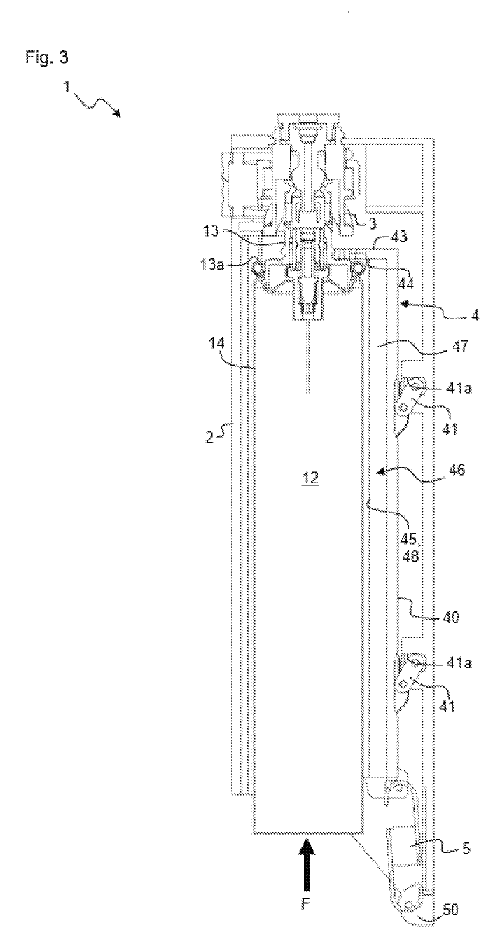

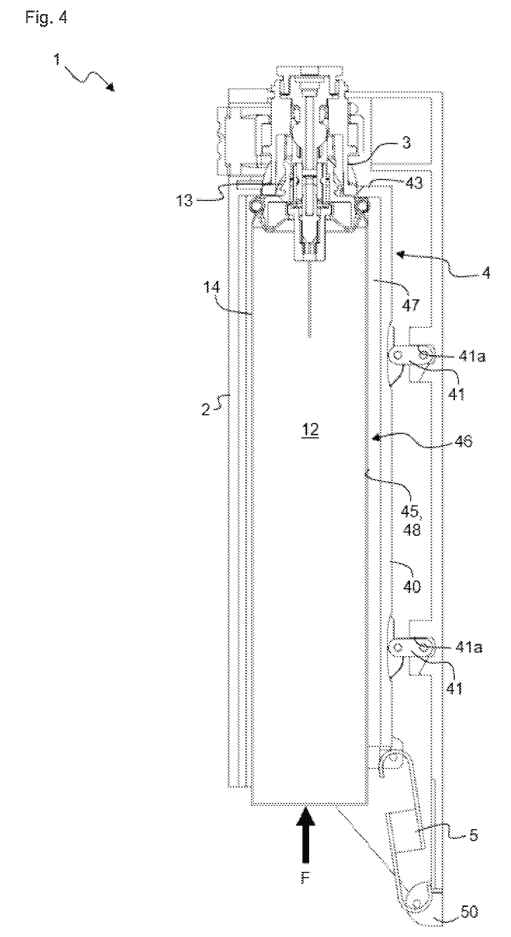

The fuel cartridge 12 (see FIGS. 3 and 4) comprises an outlet 13 at one end and a side wall 14 forming a chamber inside which fuel is held. In this example, the combustion-powered tool 10 also comprises a temperature control device 15 for heating the fuel cartridge 12.

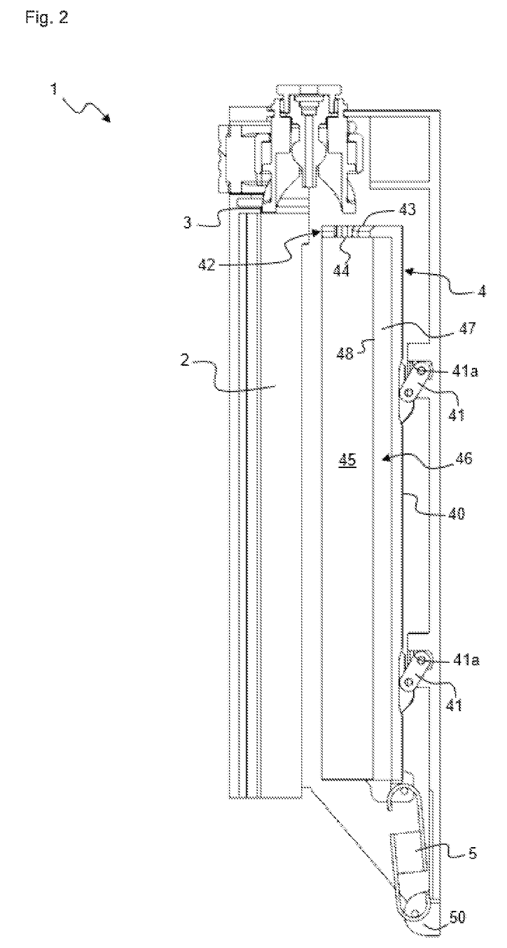

FIGS. 2 to 4 show the fuel cartridge holder 1 that comprises an open-ended receptacle 2 to hold the fuel cartridge 12, a connector 3 at a closed end for fluid connection to the outlet 13 on the fuel cartridge 12, and a gripper 4 for engaging part of the side wall 14 of the fuel cartridge 12 when it is connected to the connector 3.

The gripper 4 comprises an elongate member 40 movably connected by at least one, in this case two, swivel links 41. In this example, each swivel link 41 is pivotally connected to a wall of the receptacle 2 at one end and to the elongate member 40 at its other end, thereby resulting in a four-bar mechanism configuration.

The elongate member 40 on the gripper 4 comprises a stop 42 provided by a flange 43 that extends from the elongate member 40. The flange 43 comprises a stop surface 44 configured to be engaged by the fuel cartridge 12 when it is inserted into the holder 1.

The elongate member 40 on the gripper 4 also comprises a partially cylindrical engagement surface 45 for engaging on the side wall 14 of the fuel cartridge 12 over most of its length. The flange 43 extends radially from the engagement surface 45 of the elongate member 40. As such, the stop surface 44 is substantially radial, or perpendicular to the engagement surface 45.

With this arrangement, the gripper 4 is actuated by the fuel cartridge 12 from a retracted position (as shown in FIG. 4) to a deployed position (as shown in FIG. 4) to engage the fuel cartridge 12. A tension spring 5 connects the elongate member 40 on the gripper 4 to a bracket 50 at the open end of the receptacle 2. The tension spring 5 biases the gripper 4 toward its retracted position.

More specifically, when the fuel cartridge 12 is inserted into the receptacle 2, a shoulder 13a surrounding the outlet 13 on the fuel cartridge 12 engages with the stop surface 44 on the gripper 4. Thus, a force F applied to push the fuel cartridge 12 into the holder 1 and to connect the outlet 13 on the fuel cartridge 12 to the connector 3 causes the gripper 4 to move from its retracted position to its deployed position.

A stop 41a is adjacent to the swivel connection that connects each swivel link 41 to the wall of the receptacle 2. These stops 41a limit the rotational movement of the swivel links 41, which would otherwise cause the gripper 4 to retract relative to the fuel cartridge 12.

The gripper 4 also comprises a resilient member 46 that forms the engagement surface 45 so as to ensure contact over substantially all of the engagement surface 45. The resilient member 46 comprises a foam material 47, for example, and a metal foil 48 on the foam material 47, which forms the engagement surface 45.

The temperature control device 15 is operationally connected to the gripper 4. More specifically, the temperature control device 15 is operationally configured to heat the metal foil 48 forming the engagement surface 45, which in turn heats the fuel cartridge 12. The person skilled in the art will be aware that the force applied by gripper 4 to engage the metal foil 48 with the side wall 14 on the fuel cartridge 12 ensures good thermal contact between them, thereby improving heating efficiency.

The person skilled in the art will understand that the embodiments described above can vary in many ways.

### List of Reference Numbers

1 fuel cartridge holder

10 combustion-powered tool

11 combustion chamber

12 fuel cartridge

13 fuel cartridge outlet

13a fuel cartridge shoulder

14 fuel cartridge side wall

15 temperature control device

2 open-ended receptacle

3 connector

4 gripper

40 elongate gripper member

41 swivel link

41a swivel link stop

42 gripper stop

43 gripper flange

44 gripper stop surface

45 gripper engagement surface

46 resilient gripper member

47 foam material

48 metal foil

5 tension spring

50 bracket

F force

1. An energy storage device holder for a driving tool, the energy storage device holder comprising:
an open-ended receptacle configured to hold an energy storage device configured to provide power to the driving tool;
a connector at a closed end of the receptacle and configured to connect with the energy storage device; and
a gripper engagable with at least part of a lateral side of the energy storage device when connected to the connector, the gripper movable from a retracted position to a deployed position to engage the energy storage device.

2. The energy storage device holder of claim 1, wherein the gripper is configured to be actuated from the retracted position to the deployed position by a force applied to push the energy storage device into the energy storage device holder and/or to connect the gripper to the connector.

3. The energy storage device holder of claim 2, wherein the gripper comprises a stop engagable by the energy storage device when the energy storage device is inserted into the energy storage device holder.

4. The energy storage device holder of claim 3, wherein the gripper is movably connected to the energy storage device holder by a swivel link so that the force applied to push the energy storage device into the energy storage device holder causes the gripper to move to the inside of the receptacle from the retracted position to the deployed position.

5. The energy storage device holder of claim 3, wherein the gripper comprises an elongate member with an engagement surface engagable with a lateral side of the energy storage device over most or all of the length of the energy storage device.

6. The energy storage device holder of claim 5, wherein the engagement surface is at least partially cylindrical.

7. The energy storage device holder of claim 5, wherein the gripper comprises a resilient member that forms the engagement surface so as to ensure contact over substantially all of the engagement surface.

8. The energy storage device holder of claim 7, wherein the resilient member comprises a foam material.

9. The energy storage device holder of claim 5, wherein the stop comprises a flange with a stop surface substantially perpendicular to the engagement surface and that is configured to be engaged by the energy storage device when the energy storage device is inserted into the holder.

10. The energy storage device holder of claim 1, wherein the gripper is biased toward the retracted position.

11. The energy storage device holder of claim 10, wherein the gripper is biased toward the retracted position by a spring.

12. A driving tool comprising the energy storage device holder of claim 1.

13. The driving tool of claim 12, which includes a temperature control device operationally connected to the gripper and configured to one of heat and cool the energy storage device held in the receptacle.

14. The driving tool of claim 13, which includes a combustion chamber fluidly connected to the connector on the energy storage device holder and a fuel cartridge with a side wall and an outlet fluidly connected to the connector on the receptacle, wherein the gripper is in the deployed position to engage the fuel cartridge.

15. The driving tool of claim 12, which is a nailer or a stapler.
